(19) United States
(12) Patent Application Publication
(10) Pub. No.: US 2016/0170995 A1
(43) Pub. Date: Jun. 16, 2016

(54) METHOD FOR PROCESSING OF SEARCH RESULTS

(71) Applicant: Bodo Wiska, Berlin (DE)

(72) Inventor: Bodo Wiska, Berlin (DE)

(21) Appl. No.: 14/968,347

(22) Filed: Dec. 14, 2015

Related U.S. Application Data
(60) Provisional application No. 62/091,649, filed on Dec. 15, 2014.

(51) Int. Cl. G06F 17/30

(52) U.S. Cl. CPC G06F 17/3053; G06F 17/30554

(57) ABSTRACT

Search results of an Internet search or a database search are processed and displayed on a display device. A sorted list of search results to a search query is received; a plurality of valuation criteria for valuating the elements of the list is defined; the elements of the list are valuated according to the valuation criteria and arranged in a multidimensional space. A distance of an element in the multidimensional space from a center of the multidimensional space depends on the position of the element in the list. A respective direction vector in the multidimensional space is assigned to each valuation criterion. A direction-related position of the element relative to the center of the multidimensional space depends on the valuations of the element with respect to the valuation criteria.

### CROSS-REFERENCE TO RELATED APPLICATIONS

This application claims priority to and the benefit of U.S. Provisional Patent Application No. 62/091,649, filed Dec. 15, 2015, the contents of which are herein incorporated by reference in their entirety as if fully set forth herein.

### FIELD

The present invention relates to a method for processing of search results of an Internet search or a database search to display the search results on a display device, such as a display of a personal computer or a mobile terminal.

### BACKGROUND

Results of such an online search or stationary database search are usually provided in the form of a result list or hit list, wherein the sorting order or sequential order of the items on this list reflects a relevance of the elements with respect to a search query, i.e. the considered relevant elements can be found at the beginning of the list; the presumably less relevant elements can be found further toward the end of the list.

Such a linear display of the search results has the disadvantage that a user is unable to recognize possibly existing relationships between individual elements of the result list and to obtain an overview of the entire result.

It is therefore an object of the present invention obviate these disadvantages of the prior art.

### SUMMARY

The object is attained with a method for processing of search results of an

Internet search or a database search for displaying the search results on a display device of an electronic device, with the steps of receiving a sorted list of the search results in response to a search query; defining a plurality of valuation criteria for valuating elements of the list; assigning a valuation to the elements of the list according to the valuation criteria; and arranging the elements of the list in a multidimensional space. The distance of an element in the multidimensional space from a center of the multidimensional space depends on a position of the element in the list, and the direction-related position of the element in relation to the center of the multidimensional space depends on the valuation of the element in accordance with the valuation criteria. A respective direction vector is assigned to each valuation criterion in the multidimensional space. The object is furthermore attained with a computer program configured to execute the above method.

A preferred embodiment of a method for processing of search results of an Internet search or a database search for displaying the search results on a display device, such as a screen or a display of an electronic device, includes the following steps:

In a first step, a list of search results sorted by relevance with respect to a search query is received, for example, from a search engine or the like. However, if the method is carried out for example at an operator of a search engine itself, the list may also be a result of an at least temporary or partial analysis of the search query at the operator of the search engine. The term “list” in the context of the present invention is intended to have a broad meaning, e.g. in the sense of a set, i.e. the term “list” does not yet define an internal structure or arrangement of the elements of the list in relation to each other. The elements of the list are sorted such that the relevance of any two elements with respect to the search query is comparable for the two elements of the list based on the sorting. The sorting is thus an ordering relationship, similar to the mathematical relation “≦”; in particular, the sorting is transitive. A position in the list can therefore be assigned to each element of the list, wherein several elements of the list may occupy the same position. Preferably, the list is sorted linearly, so that each item is given a unique position in the list. This list may include a plurality of search results, which cannot all be displayed at the same time. Results of only limited relevance may also be part of the list. In general, this result list or hit list is sorted so that those elements of the list located at the beginning of the list have the highest relevance with respect to the search query, whereas elements of the list located further back in the list have lower relevance. The search query may, as is commonly known, relate to one or more search terms. The element of the list may be related to each other in different ways, regardless of their relevance with respect to the search query. In the case of an Internet search, the element of the list may be, for example, websites which may be linked to each other—in other words, have a special relationship to each other. Such relationships, if they exist, may be received in the first step together with the list, i.e. the elements of the list continue to include this information, and this information can also be used in conjunction with the present method for processing of the search results, as will be described in detail below.

In a further step, a plurality of valuation criteria is defined to valuate the elements of the list. As will be apparent from the following, preferably three and more preferably four valuation criteria are determined. The valuation criteria are fundamentally independent of the search query, but may, as set out below, also include references to the search query. The valuation criteria may, at least partially, be specified by a user. Alternatively or additionally, valuation criteria may be determined automatically, as will be explained in more detail below.

Thereafter, the elements of the hit list are valuated according to previously defined valuation criteria. As a rule, each element of the hit list is valuated separately based each of the valuation criteria. The valuation of an element with respect to a valuation criterion may, for example, be indicated by a numerical value, for example, a value between 0 and 1. However, it may also be sufficient to distinguish a high valuation of an element with respect to a valuation criterion from a low valuation with respect to this valuation criterion.

The elements of the list are then arranged in a multidimensional space.

According to a first preferred embodiment, the elements of the list are arranged in a plane, i.e. in a two-dimensional space, preferably in a manner which at least resembles a map display. The items in the list then correspond approximately to places or cities. Such an arrangement is then used for a subsequent representation on a two-dimensional display device, such as for example a conventional display.

According to a second preferred embodiment, the multidimensional space is a three-dimensional space, i.e. the elements of the list are arranged in a three dimensional space. Such an arrangement is used for a subsequent three-dimensional representation, for example by way of a 3D imaging method, such as a holographic representation.

The multidimensional space has a predetermined center, which may for example correspond to an origin of a coordinate system. A distance of an element of the list arranged in the multidimensional space from the center of the multidimensional space depends on the original position of the element in the list. As a rule, those elements located at the beginning of the list have a small distance to the center of the multidimensional space. The distance of the element from the center of the multidimensional space will increase with increasing position in the list. This ensures that the elements with the greatest relevance with respect to the search query according to the original order of the list are always positioned at the center or at least near the center of the multidimensional space and can hence be immediately identified as highly relevant.

A direction-related position of the element relative to the center, i.e., whether the element is located, for example, rather above or below, rather to the right or left, or rather before or behind the center of the multidimensional space, depends hereby on the valuation of the element with respect to the valuation criteria. For this purpose, a respective direction vector in the multidimensional space is assigned to each valuation criterion. For example, it is evident that four directional vectors can be provided in two-dimensional space, each corresponding to the positive and negative X and Y axes of a conventional two-dimensional coordinate system. In analogy to a map, the direction vectors correspond here to the four compass directions (N, S, E, W). Likewise, three direction vectors, which start ay the origin and are rotated with respect to the other two by 120°, may be provided. In principle, a greater number of direction vectors is possible, with each direction vector pointing away from the origin of the coordinate system in a different direction. Six directional vectors may be used in a three-dimensional space, which may each correspond to the positive and negative X, Y and Z-axis of a conventional three-dimensional coordinate system. The direction vectors are preferably arranged with respect to each other in a regular pattern, i.e. the angles between adjacent direction vectors are generally equal. Each of the direction vectors is hereby assigned to exactly one of the valuation criteria. If an item in the list has a high value, for example, with respect to the first direction vector corresponding, for example, to the positive X-axis, then the element will be offset with respect to the center in the direction of the positive X-axis. If an element has a high or at least a positive valuation with respect to a plurality of valuation criteria, then the element can similarly be arranged with respect to the valuation criteria associated with the direction vectors in a similar fashion, wherein proportions of valuations with respect to opposite direction vectors can partially cancel each other out.

In a further step, elements of the list can then be displayed in the previously determined order on a multidimensional display device of an electronic device, i.e. for example on a display of a smartphone or a tablet, or on a screen of a personal computer, but also by a display device configured for 3D image rendition, such as a holographic display. As a rule, only an adjustable number of elements of the list are displayed so that the display is readable. Elements with higher relevance are hereby preferentially displayed. The display can be scaled such that the available display area is always fully utilized regardless of the number of displayed elements of the list.

The aforementioned valuation criteria can be determined in various ways. For example, valuation criteria from various groups described in the form of examples can be combined.

According to a first preferred embodiment, at least one of the valuation criteria is derived from an internal link structure of the elements of the list. In this case, as previously indicated, information about relationships between the elements of the list is valuated by the present method. Typically, search results, especially search results from an Internet search having results that usually match websites, are analyzed to determine whether references (hyperlinks) exist between the individual elements. The sum of all of these references that exist between the elements of the list is referred to in the present context as a link structure. The link structure may also include references that point to elements of the list or originate from elements of the list, wherein the respective “other end” of the reference, i.e. that element from which the reference originates or to which the reference points, need not necessarily be part of the list. In this way, additional information describing linking of the elements of the list with data records that are not part of the list, but are associated with elements of the list, can be captured. The link structure can include, for example, clusters or strongly connected components of elements, which are characterized in that numerous references exist between elements of the cluster or the component. Other recognizable structure elements of the link structure are, for example, elements with an above average number of incoming and/or outgoing references.

These and similar structural elements of the link structure can each define a valuation criterion. A valuation of an element of the list with respect to such a valuation criterion depends then on a relative linking of the element within the link structure with respect to the respective valuation criteria. For example, if different clusters or related components of the link structure are defined as valuation criteria, then a valuation of an element with respect to a cluster can for example be high if it is part of the corresponding cluster and is strongly linked in the cluster. An alternative variant for valuating an element of the link structure with reference to a cluster or a specific element of the list is the distance of the element from the cluster or the specific element, i.e. the minimum number of references within the link structure via which the cluster or the specific element can be reached from the element. It will be understood that alternatively similar purely structural valuation criteria can be defined. In this embodiment the valuation criteria can advantageously be determined fully automatically, without any user interaction. Also, there is no dependence on the search query, i.e. such valuation criteria exist in an analogous manner for any search query.

According to a second preferred embodiment, at least one of the valuation criteria can be determined based on supplementary search terms. The supplementary search terms may be extracted automatically from the elements of the list, i.e. from the data sets corresponding to the elements of the list. Alternatively, the supplementary search terms may also be specified by a user. These additional keywords are, in accordance with a first variant, independent of the search query that forms the basis for the result list. In other words, the supplementary search terms according to the first variant do not enter in the original search query that leads to the result list. Alternatively, according to a second variant, one or more of the supplementary search terms may already also be part of the original search query.

A review of an element of the list with respect to a valuation criterion that is determined based on a supplementary search term then corresponds to a relevance of the element of the list with respect to the supplementary search term associated with the valuation criteria. In other words, for example, the list of items can be resorted so that those elements, which have the greatest relevance for the supplementary search term, may be at the beginning of the reordered list, with a decreasing relevance with reference to the supplementary search term being reflected position farther back in the reordered list. The position in the so reordered list can then be understood as a valuation of the element with respect to the supplementary search term, with a high valuation corresponding to a position at the beginning of the reordered list and a low valuation being assigned to elements is toward the back of the reordered list.

It will be understood that the supplementary search terms are selected or determined so that the elements of the list can be sufficiently separated by these supplementary search terms in the manner described above. In other words, it is an object to differentiate between the elements of the list based on the supplementary search terms so that, for a vast majority of elements of the list, these elements are valuated noticeably higher with respect to one or optionally two of the valuation criteria than with respect on the other valuation criteria. It is also the object that for each supplementary search term at least one non-negligible proportion of the elements of the list is present that has a noticeable high rating with respect to this search term. This approach then enables a clearly recognizable distribution of the elements in the multidimensional space according to the above-described arrangement.

In particular, the supplementary search terms may have antonym term pairs (antonyms). One element of the list can be expected to have a high valuation with respect to no more than one term of a pair of antonym terms. When direction vectors pointing in the opposite direction in the multidimensional space are then assigned to the two antonyms, the element can be uniquely positioned in the multidimensional space in this direction or the other of these directions.

According to another preferred embodiment, one or more valuation criteria may be numerical criteria which allow, for example, an arrangement of the elements of the list with respect to a time axis. A date can be assigned in a unique way to each element of the list, which usually corresponds to a web page, for example, a last update date of the website or the like.

In addition to the actual elements of the list, elements of the link structure, i.e. references between the elements of the list, can be at least partially displayed on the display device. With reference to the above-mentioned map analogy, references between the elements of the list can be compared to paths or roads between places or cities. Information can be transported according to the way in which such reference is displayed (color, line shape or line thickness), i.e. in particular according to the strength or relevance of the reference. The structure of the total amount of the hit list is then particularly easy to comprehend. Furthermore, highlighted elements of the list which are, for example, referenced more often by other elements of the list are immediately recognizable.

In general, the items in the list and optionally portions of the link structure can be, as already mentioned, scaled on the display, i.e. zoomed in and zoomed out in the representation. On the one hand, by zooming out, an overall view of the structure of the search results can be obtained, for example, when large, clearly separated clusters are recognizable. On the other hand, the internal structure of one or more of these clusters can be analyzed more accurately by zooming in on the display. Scaling the display makes it also possible to vary the number of elements of the list that are simultaneously displayed.

According to another preferred embodiment, related elements of the list can be highlighted on the display, for example, highlighted in color, in analogy to a topographic map. The relationship between these elements may be thematic in nature and may be derived, for example, by analyzing the elements on the list, i.e., the relevant records or websites corresponding to the list elements. In particular, the elements may also be interrelated with respect to any of the aforementioned valuation criteria, for example by highlighting elements of the list that have with respect to a valuation criterion a valuation above a predetermined threshold value.

A method of the aforedescribed type provides numerous advantages compared to a one-dimensional representation of the results of an Internet search or a database search. Structural and/or content-related, i.e. semantic relationships between the elements of the list can be automatically depicted with the multidimensional representation of search results based on the valuation criteria, depending on the selection of the valuation criteria. In this way, a user immediately has a good overview of the internal structure of the results of the search list, without requiring additional search queries for this purpose. The display also enables identification of important elements of the list, even when these elements were not found in the top positions of the original representation of the list, for example those items in the list referred to by a number of other elements of the list. Due to the scalability of the display, related substructures of the hit list can be analyzed separately. It will be understood that a relevance determined according to the original arrangement in the one-dimensional list remains recognizable unchanged, based on a distance of an element from the center of the multidimensional space.

A preferred embodiment of a computer program according to the invention, when executed on a computer, is configured to carry out a method of the aforedescribed type. According to a first preferred embodiment, with the exception of the step of displaying the items in the list, the method is carried out with the instance that provides the linearly sorted hit list in response to the search query, i.e. in particular at an operator of a search engine. In this way, due to the extensive resources of such an instance, very large hit lists for determining valuation criteria and for valuating the elements of the list in accordance with the valuation criteria can be analyzed. According to an alternative preferred embodiment, this computer program can be configured, for example as an extension of a Web browser, to automatically display a result list received from a search engine at the user and/or in response to specific user inputs with respect to preferred valuation criteria, in particular with respect to supplementary search terms, in the manner described above on a display device of an electronic device, or to at least prepare such a display by providing the arrangement of the elements in the multidimensional space.

### BRIEF DESCRIPTION OF THE DRAWINGS

The present invention will now be described by way of example with reference to the accompanying drawings. For ease of visualization, a two-dimensional plane is used as a multidimensional space. It will be understood that the following discussion can be readily extended directly to three or more dimensions. The accompanying drawings show in:

FIG. 1: steps of a preferred embodiment of a method for processing of search results;

FIG. 2: a hit list of a conventional linear list structure;

FIG. 3: a table illustrating a valuation of the elements of the list from FIG. 2 with respect to four different valuation criteria;

FIG. 4: an arrangement of the elements of the list from FIG. 2 in a plane with respect to four directional vectors and depending on the position of items in the list according to FIG. 2, as well as valuations of the elements in accordance with the valuation criteria of FIG. 3;

FIG. 5: a display of elements of the list of FIG. 2 according to the arrangement of FIG. 4 on a display device of an electronic device; and

FIGS. 6A and 6B: illustration of exemplary system configurations.

### DETAILED DESCRIPTION

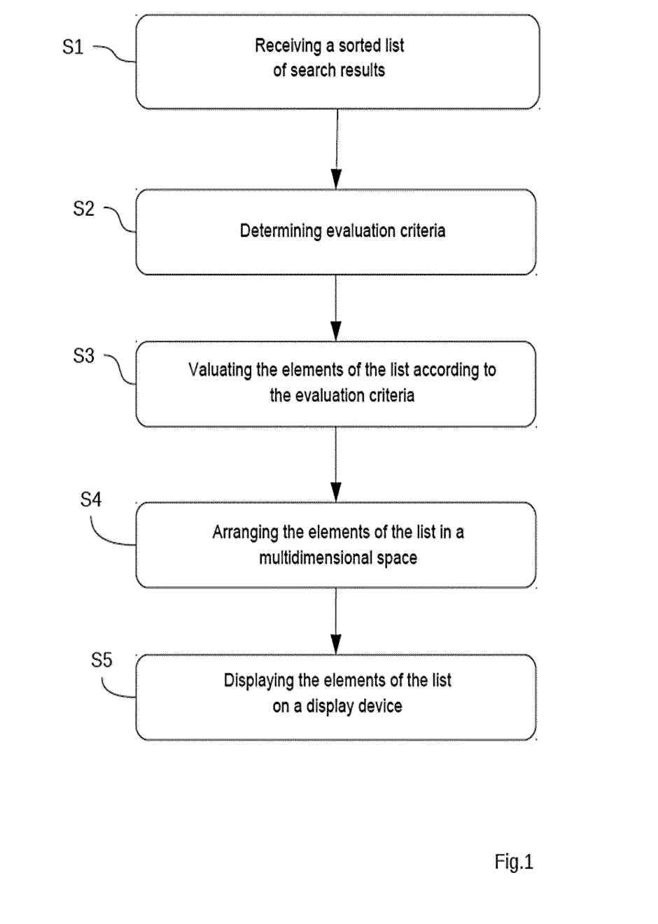

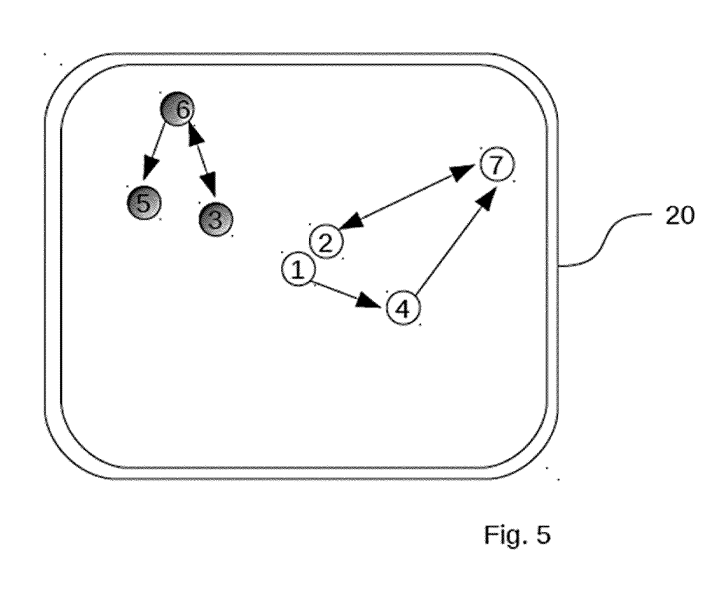

A method for processing of search results of a search illustrated in FIG. 1, in particular an Internet search, for displaying the search results on a display device, such as a display 20 (see FIG. 5) includes the following steps:

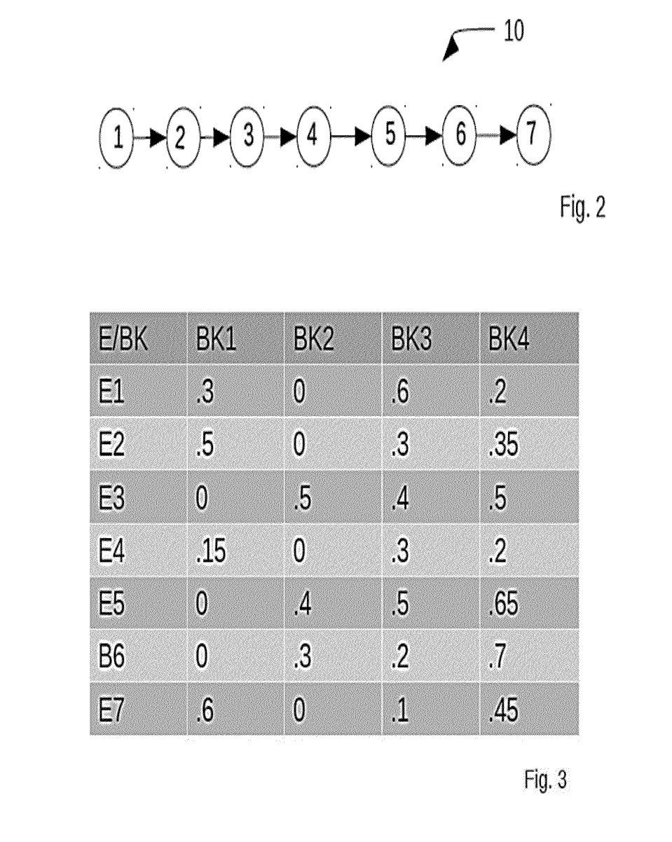

In a first step S1, a linearly ordered list 10 of search results from a given search query is received, for example, at a search engine. Such a list 10 is illustrated in FIG. 2 by way of example and includes (for the sake of easier visualization only) seven elements. The arrangement of the elements in the list 10, from 1 to 7, indicates the relevance of the elements with respect to the search query, with the element E1 having the highest relevance and the element E7 having the lowest relevance.

In step S2, a plurality of valuation criteria for valuating the elements of the list 10 is determined. In the illustrated example, four valuation criteria BK1 to BK4 are to be used for valuating an element (see FIG. 3). The valuation criteria can be derived from an internal link structure of the elements of the list. Alternatively or additionally, a supplementary search term can be used as a valuation criterion and items in the list 10 can be resorted with respect to their relevance to the search term, whereafter a valuation with respect to this valuation criterion can be derived based on this new order. Alternatively, a temporal arrangement of the elements may also be used as a valuation criterion, for example with reference to a creation date or an update date of a data set corresponding to an element of the list.

In a step S3, based on the valuation criteria determined in step S2, the elements E1 to E7 of the list 10 from FIG. 2 are each valuated with respect to the valuation criteria BK1 to BK4. Such a valuation can be expressed, for example, as a normalized numerical value, for example as a value between 0 and 1, as is indicated in FIG. 3

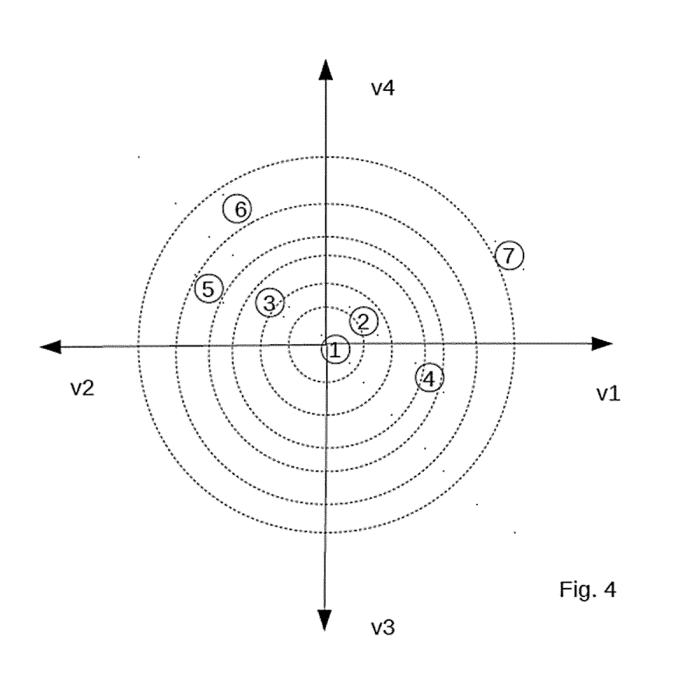

It is noticeable with respect to the valuation criteria BK1 and BK2 that each of the elements E1 to E7 has a zero valuation only with respect to exactly one of these two valuation criteria. As indicated with reference to FIG. 4, with respect to a spatial arrangement of the elements of the list from FIG. 2 to be described in more detail below, direction vectors v1 and v2 aligned in opposite directions in a plane are associated with the valuation criteria BK1 and BK2. With a positive valuation with respect to the valuation criteria BK1, the corresponding element is then positioned relative to the origin of the coordinate system indicated in FIG. 4 in the direction of the direction vector v1. This applies to the elements E1, E2, E4 and E7. Conversely, with a positive valuation with respect to the valuation criterion BK2, the corresponding element is then positioned to the left of the origin, i.e. in the direction of the direction vector v2 (see FIG. 4, elements E3, E5 and E6).

The valuation criteria BK1 and BK2 may, for example, arise from the fact that the elements of the list 10 of FIG. 2, which may all correspond to Internet pages, are arranged in ascending order with respect to a respective time assigned to the Internet pages, for example, a latest update date. In this arrangement, a median element, i.e. a central element, is determined. A positive valuation with regard to the valuation criterion BK1 then shows a deviation from the update date of the median element in the past, whereas a positive valuation with regard to valuation criterion BK2 shows a deviation of the update date relative to median element in the future.

As indicated with reference to the valuation criteria BK3 and BK4, with which the direction vectors v3 and v4 are associated in FIG. 4, which also point in opposite directions and are in the plane orthogonal to the direction vectors v1 and v2, the elements of the list 10 can also have a positive valuation with respect each of these two conceptually conflicting valuation criteria. The valuation criteria BK3 and BK4 can here be derived, for example, from supplementary search terms, as described above. However, it is possible that an element of the list 10 can have a positive valuation for each of the two supplementary search terms that are associated with the respective valuation criteria BK3 and BK4. With respect to an arrangement of the element in the plane, for example a difference of two valuations with respect to the valuation criteria and BK3 BK4 may be used. The element E7 has, for example, a positive value with respect to each of the valuation criteria BK3 and BK4, wherein the valuation according to the valuation criterion BK4 is significantly higher. Consequently, the element is positioned in the plane, as shown in FIG. 4, above the origin and in the direction of the direction vector v4. Conversely, the element E4 which has a slightly higher valuation with respect to the valuation criterion BK3 is positioned slightly below the origin, i.e. in the direction of the direction vector v3. The other elements can be arranged in an analogous manner, as will be immediately apparent from the FIGS. 3 and 4.

A distance of an element E1 to E7 in the plane in FIG. 4 is hereby substantially determined by a position of the element in the original list 10 of FIG. 2, i.e. dependent on the relevance of the element with respect to the search query originally determined by the search engine. As a consequence, the most relevant elements such as the elements E1 and E2, respectively, are arranged at the center of the plane, i.e. close to the origin. Less relevant elements have an increasing distance from the center of the plane, as indicated in FIG. 4 by concentric circles with increasing diameter.

In a step S4, the elements of the list 10 are arranged in a plane according to the aforedescribed guidelines and in accordance with to the method described here by way of example (see FIG. 1).

According to a step S5, the elements of the list 10 are lastly displayed in the plane on a display device of an electronic device in the arrangement defined in step S4 (see FIG. 5).

An arrangement of the elements of the list from FIG. 2 as determined in the aforedescribed manner allows a clear overview of internal structures of the result list, as illustrated with reference to FIG. 5.

Accordingly, the elements of the list 10 of FIG. 2 are now displayed on a display device 20 of an electronic terminal, for example on a screen of a tablet computer, according to the order illustrated in FIG. 4. The elements E1 and E2 are visible in the center and can hence be directly identified as the most relevant hits. The way in which the elements are displayed is determined by a concrete implementation. A member of the hit list can, for example, be displayed only in an abstract fashion, as a geometric element (e.g. as a circle, as shown in FIG. 5). When pointing with an input device, e.g. a mouse or the like, to the element, an abbreviated content or at least a title of the data set corresponding to the element may be displayed.

In addition, individual references (links) between the elements of the list 10 are displayed on the display, which enables easy visualization of clusters and related structures of the hit list 10. Lastly, thematically related elements of the list 10 may be highlighted on the display in color (see the elements E3, E5 and E6). This allows a user to visually detect additional structural relationships of the hit list 10 in a simple manner and to valuate the hit list with respect to these additional structural relationships.

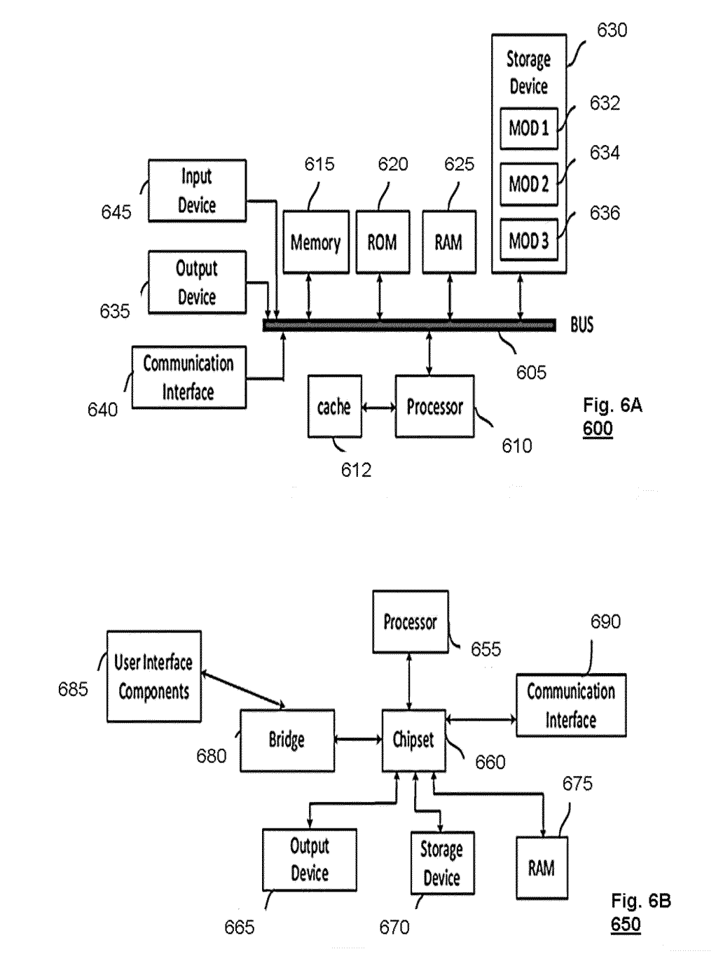

FIG. 6A, and FIG. 6B illustrate exemplary possible system configurations. The more appropriate configuration will be apparent to those of ordinary skill in the art when practicing the present technology. Persons of ordinary skill in the art will also readily appreciate that other system configurations are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some configurations the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

What is claimed is:

1. A method for processing of search results of an Internet search or a database search for displaying the search results on a display device of an electronic device, comprising the steps of:
receiving a sorted list of the search results in response to a search query;
defining a plurality of valuation criteria for valuating elements of the list;
assigning a valuation to the elements of the list according to the valuation criteria; and
arranging the elements of the list in a multidimensional space, wherein a distance of an element in the multidimensional space from a center of the multidimensional space depends on a position of the element in the list, and wherein a direction-related position of the element in relation to the center of the multidimensional space depends on the valuation of the element in accordance with the valuation criteria, wherein a respective direction vector is assigned to each valuation criterion in the multidimensional space.

2. The method of claim 1, wherein the multidimensional space is represented by a two-dimensional plane, with the elements of the list being arranged in the two-dimensional plane.

3. The method of claim 1, wherein the multidimensional space is represented by a three-dimensional space, with the elements of the list being arranged in the three-dimensional space.

4. The method of claim 1, wherein at least one of the valuation criteria is derived from an internal link structure of the elements of the list, and wherein the valuation of an element of the list with respect to the at least one valuation criterion depends on a relative linking of the element within the internal link structure.

5. The method of claim 1, wherein at least one of the valuation criteria is determined based on supplementary search terms, wherein a valuation of an element of the list with respect to a supplementary search term is determined as a relevance of the element with respect to the supplementary search term.

6. The method of claim 5, wherein the supplementary search terms are specified by a user.

7. The method of claim 5, wherein the supplementary search terms include pairs of antonyms.

8. The method of claim 1, and further comprising displaying the elements of the list on the display device commensurate with the arrangement of the elements in the multidimensional space.

9. The method of claim 8, and further comprising at least partially displaying, in addition to the elements of the list, an internal link structure of the elements of the list.

10. The method of claim 8, wherein the elements are displayed on the display device in a scaled fashion.

11. The method of claim 8, and further comprising highlighting interrelated elements of the list.

12. The method of claim 8, and further comprising highlighting elements that are similar with respect to a valuation criterion.

13. A computer program stored on a non-transitory computer-readable medium, which when loaded into a memory of a computer and executed on the computer, causes the computer to:
receive a sorted list of the search results in response to a search query;
define a plurality of valuation criteria for valuating elements of the list;
assign a valuation to the elements of the list according to the valuation criteria; and
arrange the elements of the list in a multidimensional space, wherein a distance of an element in the multidimensional space from a center of the multidimensional space depends on a position of the element in the list, and wherein a direction-related position of the element in relation to the center of the multidimensional space depends on the valuation of the element in accordance with the valuation criteria, wherein a respective direction vector is assigned to each valuation criterion in the multidimensional space.
